(19) United States
(12) Patent Application Publication
(10) Pub. No.: US 2026/0030821 A1
(43) Pub. Date: Jan. 29, 2026

(54) SYSTEM AND METHOD OF CONVERSATIONAL GAZE CONTROL FOR COMPUTER ANIMATION

(71) Applicant: JALI INC., Toronto (CA)

(72) Inventors: Yifang PAN, North York, CA (US); Karan Singh, Toronto (CA); Rishabh Agrawal, London (CA); Pif Edwards, Toronto (CA); Chris Landreth, Toronto (CA); Eugene Fiume, Burnaby (CA)

(21) Appl. No.: 18/785,109

(22) Filed: Jul. 26, 2024

(51) Int. Cl. G06T 13/40; G06T 17/00

(52) U.S. Cl. CPC G06T 13/40; G06T 17/00

(57) ABSTRACT

A system and method of determining conversational gaze control for computer animation of a character. The method including: receiving transcripted speech audio; determining time sequences of gaze transition targets for a series of time-steps using a state machine that resolves between direct focus and aversion at each time-step; determining trajectories of head motion and gaze of the character for each time-step using the determined gaze transition targets; and outputting the trajectories of head motion and gaze for computer animation of the character.

### TECHNICAL FIELD

The following relates generally to computer animation and more specifically to a system and method of conversational gaze control for computer animation.

### BACKGROUND

A person's head, through rhythmic gestural motion, and a person's eyes, through subtle spatio-temporal changes in gaze, play a quintessential role in expressive, non-verbal communication. In a conversational setting, the head and eyes act as moderators: indicating thought, attentiveness, comprehension, engagement, in addition to turn transitions, to mediate the flow of conversation. While hand gestures and postural shifts also support communication, the role of head and eye motion as non-verbal cues are tremendously important.

### SUMMARY

In an aspect, there is provided a method of determining conversational gaze control for computer animation of a character, the method executed on a processing unit, the method comprising: receiving transcripted speech audio; determining time sequences of gaze transition targets for a series of time-steps using a state machine that resolves between direct focus and aversion at each time-step; determining trajectories of head motion and gaze of the character for each time-step using the determined gaze transition targets; and outputting the trajectories of head motion and gaze for computer animation of the character.

In a particular case of the method, the method further comprising receiving directorial inputs from a user that are embedded within the transcripted speech audio.

In another case of the method, the directorial inputs comprise one of look-at tags to amplify salience of an object, directional tags to specify ego-centric aversion behavior, or override tags to force focus or aversion behaviour.

In yet another case of the method, the method further comprising determining visually salient portions of a setting for the computer animation to determine locations for the gaze of the character.

In yet another case of the method, determining the time sequences of gaze transition targets comprises determining a speech-based probability indicating whether to avert the gaze of the character from a conversational partner.

In yet another case of the method, the speech based probability is determined using a recurrent neural network model, the recurrent neural network model taking as input prosodic audio features and relative timing of speaking and listening turns obtained from the transcripted speech audio.

In yet another case of the method, during direct focus, look-at-points are generated on a conversational partner, and wherein, during aversion, look-at-points are generated using a random walk algorithm based on scene salience.

In yet another case of the method, transitions of the state machine are determined based on one or more of the speech-based probability, a visual salience of each scene object, and a gaze state of a conversational partner.

In yet another case of the method, determining the trajectories of head motion and gaze of the character for each time-step using the determined gaze transition targets comprises optimizing for a head rotation to a shift in gaze, and comprises interpolating a sequence of head and eye targets using a motion generator.

In yet another case of the method, optimizing for the head rotation comprises an optimization involving minimization of head rotation from a predominant focus on another character, matching a learned co-relation between head and gaze angles, and minimization of eye rotation to meet the gaze transition target.

In yet another case of the method, the motion generator comprises interpolation of a sequence of target head and eye angles determined by summing a sequence of sub-movements.

In yet another case of the method, the method further comprising adding rhythmic head motion to the trajectory of the head motion.

In yet another case of the method, the method further comprising altering fixation of the trajectory of the gaze with eye rotations where a gaze fixation interval is longer than a predetermined time interval.

In another aspect, there is provided a system of determining conversational gaze control for computer animation of a character, the system comprising a processing unit and a data storage, the data storage comprising instructions for the processing unit to execute: an input module to receive transcripted speech audio; a gaze module to determine time sequences of gaze transition targets for a series of time-steps using a state machine that resolves between direct focus and aversion at each time-step, and to determine trajectories of head motion and gaze of the character for each time-step using the determined gaze transition targets; and an output module to output the trajectories of head motion and gaze for computer animation of the character.

In a particular case of the system, determining the time sequences of gaze transition targets comprises determining a speech-based probability indicating whether to avert the gaze of the character from a conversational partner.

In another case of the system, during direct focus, look-at-points are generated on a conversational partner, and wherein, during aversion, look-at-points are generated using a random walk algorithm based on scene salience.

In yet another case of the system, transitions of the state machine are determined based on one or more of the speech-based probability, a visual salience of each scene object, and a gaze state of a conversational partner.

In yet another case of the system, determining the trajectories of head motion and gaze of the character for each time-step using the determined gaze transition targets comprises optimizing for a head rotation to a shift in gaze, and comprises interpolating a sequence of head and eye targets using a motion generator.

In yet another case of the system, the processing unit further executes a rhythmic motion module to add rhythmic head motion to the trajectory of the head motion.

In yet another case of the system, the processing unit further executes a post-processing module to alter fixation of the trajectory of the gaze with eye rotations where a gaze fixation interval is longer than a predetermined time interval.

These and other aspects are contemplated and described herein. It will be appreciated that the foregoing summary sets out representative aspects of systems and methods to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a diagram of a system of determining conversational gaze control for computer animation of a character;

FIG. 2 is a flowchart of a method of determining conversational gaze control for computer animation of a character;

FIG. 3 illustrates a flowchart of an example implementation of the method of FIG. 2;

FIG. 4 is a diagram of an implementation of gaze aversion prediction, in accordance with the system of FIG. 1;

FIG. 5 is a diagram illustrating an example per-frame gaze state machine for determining gaze and/or aversion, in accordance with the system of FIG. 1;

FIG. 6 is a diagram showing an example implementation and architecture to determine rhythmic head rotation values, in accordance with the system of FIG. 1;

FIG. 7 illustrates charts showing predictions for rhythmic head motion determined in example experiments;

FIG. 8 illustrates examples of tags used for directorial scripting and examples of their control, in accordance with the system of FIG. 1;

FIG. 9 illustrates a diagrammatic example of 3-party conversations cast as two dyadic conversations;

FIG. 10 illustrates audition data with animated head and gaze estimation and isolated rhythmic head rotation animation, for the example experiments;

FIG. 11 are charts illustrating gaze focus and/or aversion using the system of FIG. 1, statistical, and stare versus ground-truth, for the example experiments;

FIG. 12 is a chart showing results a force choice experiment conducted in the example experiments;

FIG. 13 shows screenshots of an audio-driven facial performance, generated using the system of FIG. 1, illustrating direct gaze and gaze aversion transition examples; and

FIG. 14 illustrates an example use of the system of FIG. 1 to determine gaze of an animated character to provide a realistic animation, showing circles representing gaze transition targets while the character is reading a letter.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to computer animation and more specifically to a system and method of conversational gaze control for computer animation.

Generally, animating conversational head and eye movement is a complex interplay of personality, culture, psycho-linguistics, and scene context. The present embodiments provide an advantageous approach to generating such head and eye motion from input speech audio, a tagged script, and/or a cinematographic 3D scene.

Generally, traditional audio-driven facial animation approaches have predominantly focused on the verbal production of speech by the lower face. While audio correlations, or paralingual heuristics, can animate the upper face, head and eye rotations are generally left to be animated with the rest of the articulated body. As a result, most synthetic talking faces look straight ahead, despite psycho-linguistic research stressing that at least 30% of a conversation can be spent looking away from an interlocutor.

Conversation driven is effective to guide an immersive narrative, drawing audiences into the camera frame. Other approaches for speech-driven conversational gaze has typically been based on procedural psycho-linguistic heuristics, or data-driven models trained without a cinematographic scene context.

The present embodiments advantageously make use of the fact, discovered by the present inventors, that that while speech audio is primarily responsible for the pattern and timing of gaze aversion from a conversational partner, the precise three-dimensional (3D) location of this gaze focus and/or aversion is largely determined by the cinematographic scene context. The present embodiments exploit this observation to judiciously break down conversational head and eye motion into a number of animatable components, for example: (1) speech audio-driven rhythmic head motion (e.g. head nods) and transitions of focus and/or aversion of gaze from a conversational partner; (2) script-driven emblematic head and eye gestures; and (3) scene-driven saliency to contextually refine gaze focus and/or aversion into a temporal sequence of 3D look-at points (gaze trajectories), which the present embodiments satisfy with optimal head and eye rotations.

Advantageously, the present embodiments provide audio-driven gaze focus and/or aversion and scene-driven 3D gaze refinement. The present embodiments can be advantageously integrated into an animation pipeline to automatically determine head and eye rotations. In some cases, the present embodiments also provide: a diarised and annotated dataset of conversation audio and inferred 3D scene context; an audio-driven model for rhythmic head motion; an audio-driven model that predicts temporal transitions of gaze focus and/or aversion from a conversational partner, which can be refined by a 3D scene context to produce gaze trajectories; and a gaze control approach that generates head and eye animation to optimally satisfy given gaze trajectories.

Generally, the head and eye play an important role in non-verbal communication during a conversation. Gaze transitions have at least three communicative functions. Firstly, for turn-taking to mediate dialogue, such that one averts gaze when starting to speak, and looks back at the listener to conclude a turn. Secondly, to monitor understanding by using gaze for lip-reading to better comprehend speech, or looking at the upper face to understand emotion. Thirdly, for managing arousal by looking away during moments of heightened emotion, high cognitive load, social anxiety, or when speaking with someone in power.

Generally, gaze can also be consciously used for gestures (e.g., elevator eyes, eye rolls) or for deictic purposes. Gaze is generally further attracted by visual stimuli and people with status. Cultural norms also impact head and gaze motion. For example, South Asians generally shake their head to agree, Arabs and Asians generally engage in mutual gaze more than Americans, and Chinese tend to look up while Japanese speakers look down when thinking. The present embodiments model such gaze behavior, that may not be directly related to speech or visual stimuli in a scene, using tags in a directorial script.

In 3D animation, techniques for computer facial animation can be generally classified as procedural, data-driven, or driven audio-visually by performance capture. In the context of audio-driven head and eye animation, the speech audio provides a tempo for rhythmic head motion and relevant psycho-linguistic cues for gaze focus and/or aversion.

The head of a speaker or listener is never perfectly still in conversation, instead it is constantly communicating through rhythmic and emblematic co-speech gestures; the absence of which makes a character seem robotic. Various approaches can be used to generate co-speech head and body gestures; for example, the use of state machines and Hidden Markov Models to select between a set of head gestures, such as a head nod or shake, based on prosody, and using arousal and dominance to determine head velocity and head direction. Deep learning models can also be used to produce skeletal upper body animation from audio. Various image-based talking face approaches can also be used to explicitly learn overall (rhythmic, emblematic, and gazed-based) head motion to be rendered together with an animated face. In contrast, the present embodiments advantageously determine head motion from audio but in a manner that disentangles rhythmic head motion from head motion caused by controllable gaze transitions.

With respect to gaze, dynamics of specific types of eye movements can be determined; such as micro-saccade and pupil-dilation, gaze shifts, and smooth pursuit. Patterns of gaze as attentive behavior can be determined using visual salience, such as using face detection to amplify the salience on (e.g., speaking) human faces. Various approaches to determine gaze have been used, such as networks to predict gaze trajectories from input video and motion capture, and models to synthesize gaze shifts between regions of a segmented face; however, these approaches model the gaze of an observer and not the gaze behavior of a speaker.

Advantageously, the present embodiments can use tagged scripts to determine emblematic gestures, cultural preferences, and behavior that cannot otherwise be automatically inferred from speech audio and a 3D scene context. we present a comprehensive model for conversational head and eye motion. Taking into account animator workflows, embodiments of the present disclosure combine audio-driven ego-centric gaze focus and/or aversion, refined by exo-centric 3D scene context, to determine a sequence of 3D animated gaze transitions.

Generally, given a gaze trajectory (i.e., a temporal sequence of 3D look-at points), inversely computing head (2 degrees-of-freedom (DOF)) and eye (2 DOF) rotations in order to satisfy the 3D look-at points is an under-constrained problem; and typically involves both a head and eye rotation. Proximal gaze targets (e.g., less than approximately 20°) can be achieved by rapid eye-only gaze shifts, called saccades, with velocity profiles. The relative timing and number of head and eye motions can vary based on a gaze shift needed for the target, a time to target, whether a target point is pre-planned or reactive, and an intended dwell time on the target. A general approach is to use an eye-only gaze shift threshold beyond which both the eye and head rotate. Other approaches include mass-spring models of smooth pursuit dynamics, and combinations of saccades and smooth pursuit. Embodiments of the present disclosure determine head and eye rotations as an optimization that advantageously accounts for the dwell time of a look-at point.

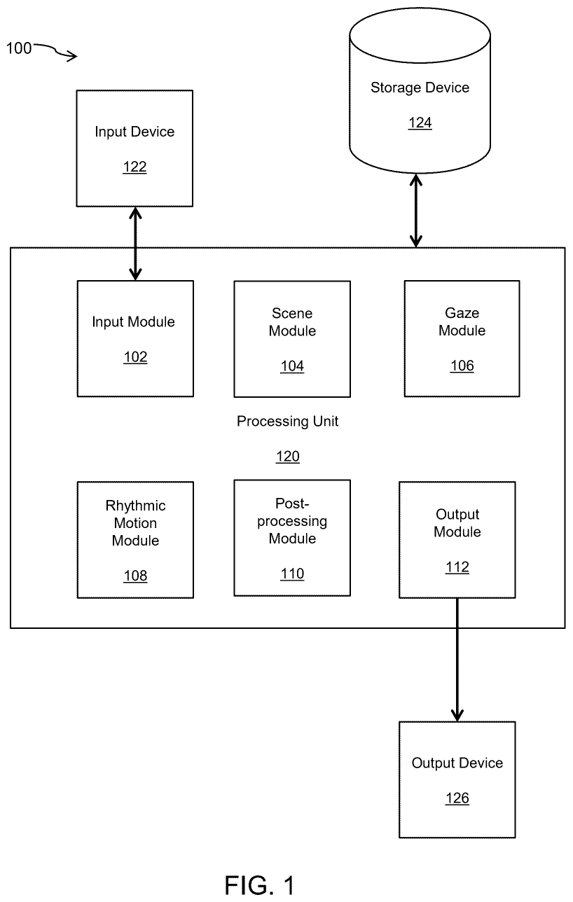

Turning to FIG. 1, a diagram of a system 100 of conversational gaze control for computer animation, in accordance with an embodiment, is shown. The system 100 includes a processing unit 120, a storage device 124, an input device 122, and an output device 126. The processing unit 120 includes various interconnected elements and conceptual/functional modules, including an input module 102, a scene module 104, a gaze module 106, a rhythmic motion module 108, a post-processing module 110, and an output module 112. The processing unit 120 may be communicatively linked to the storage device 124 which may be loaded with data, for example, input data, audio/visual data, transcript data, animation data, or the like. In further embodiments, the functions of the above modules may be combined, may be executed on further modules, may be executed on two or more processors, may be executed is a distributed fashion such as in a cloud computing environment, may be executed on the input device 122 or the output device 126, or may be executed on another type of suitable computing environment.

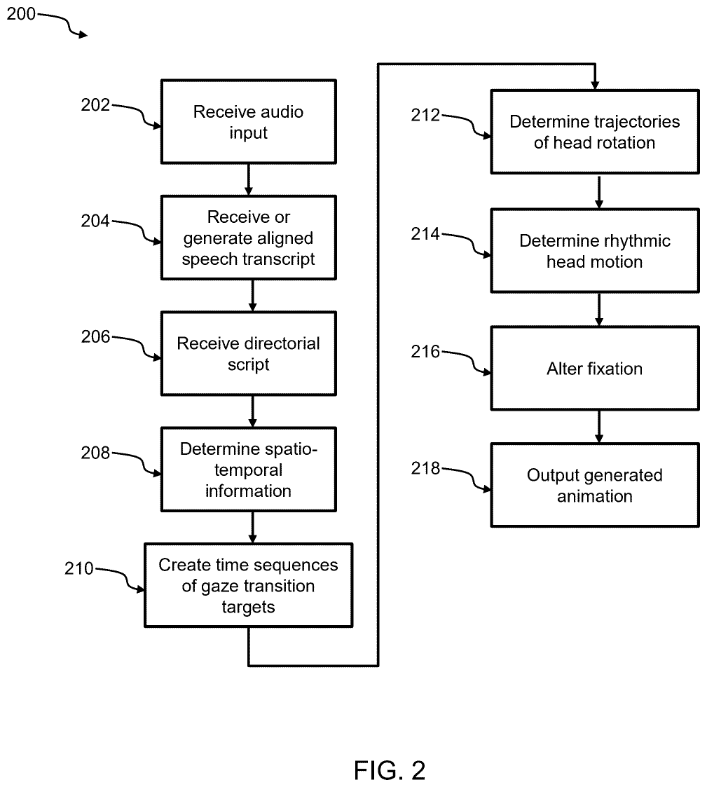

Turning to FIG. 2, a flowchart for a method 200 of conversational gaze control for computer animation, in accordance with an embodiment, is shown.

In some cases, at block 202, the input module 102 receives audio data from the input device 122 or the storage device 124. The audio data includes audio of a conversation between n (i.e., two or more) animated speakers, where the interaction is dyadic. In an example with two speakers, the audio data can include audio streams A₁(t) and A₂(t) for the two speakers in dyadic conversation; where time t∈{1 . . . T} is T frames of animation. In some cases, A single audio stream input can be diarized into two or more streams. At block 204, the input module 102 receives aligned speech transcript data from the input device 122 or the storage device 124, or the input module 202 automatically generates the aligned speech transcript data from the received audio data using any suitable audio to text methodology.

At block 206, in some cases, the input module 102 receives input from a user (e.g., a computer animator) a directorial script that includes indications of, for example, head and eye behavior, triggers for emotions, triggers for emblematic gestures, and the like. In an example, the directorial script can include tags of the form <start><end/> embedded within the audio-aligned speech transcript. In some cases, the tags can be extendable to spatially modulate scene salience; such as including <avert-up><avert-up/> tags to indicate a preferred direction of gaze aversion and/or to override certain automated gaze behavior. In some cases, these extendable tags can be embedded in, and received with, the speech text transcript received at block 204.

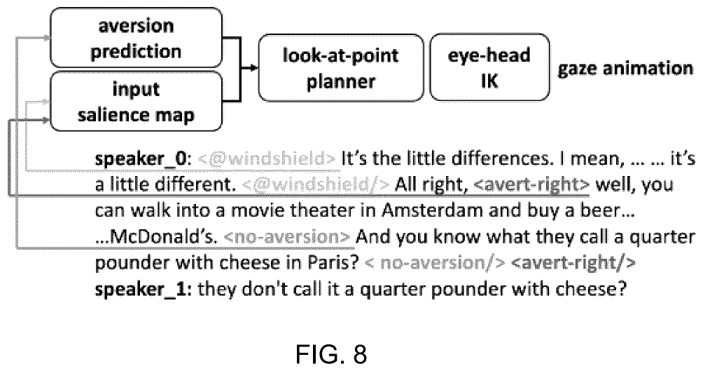

In an example, three kinds of tags as part of the directorial script are supported. Firstly, look-at tags can be used that amplify the salience of an object while the tag is active; causing an animated character to focus on an important object or reflect specific gaze behavior (e.g., looking out a windshield while driving). Secondly, directional tags can be used to specify ego-centric aversion behavior; such as averting up to reflect thinking or averting down to reflect guilt. Such tags zero out the salience of scene objects in the opposite direction for the duration of the tag. Thirdly, override tags can be used to force focus and/or aversion labelling over the tag's duration; for example, to specify speech agnostic concentration. FIG. 8 is an example illustrating tag varieties and their control, including: look-at tags, directional tags, and gaze-on/gaze-off tags.

At block 208, in some cases, the scene module 104 determines spatio-temporal information about visually salient parts of a setting for the animated conversation, referred to as a scene. The scene can be modelled using 3D positions p₁, p₂, neutral facing directions d₁, d₂ for two speakers, and a 3D position {v; (t)} and a saliency weight {s; (t)} of k animated visual hotspots i∈{1 . . . k}. Such hot-spots can be authored in the 3D scene, can be inferred automatically, or derived from intensity maps of visual saliency. The animated visual hotspots represent potential look-at points, as described herein. The modular look-at-point planner, as described herein, allows the system 100 to straightforwardly handle three-party (or n-party) conversations.

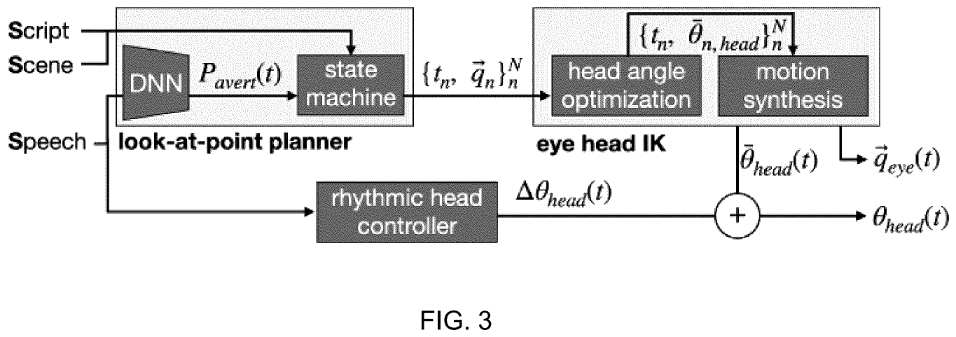

Through blocks 202 to 208, the system 100, in some cases, can take into account three streams of inputs: transcripted speech audio, 3D scene context, and directorial scripts. From these inputs, head and gaze trajectories can be determined, as illustrated in the example flowchart of FIG. 3. For ease of understanding, the system 100 can be conceptually thought of as implementing, in an example, three functional submodules: a deep-learning-informed look-at-point (gaze trajectory) planner, an inverse kinematics (IK) gaze controller, and a learned rhythmic head motion generator.

In a particular case, the system 100 models an animated head, local to a neck and/or body transform B, as a three-degrees-of-freedom (3DOF) rotation vector θₕ; with pitch, yaw and roll as rotations about x, y, z respectively. The values define a local head transform H. In some cases, the contribution of head roll (z axis rotation) in controlling gaze can be ignored for efficiency.

In a particular case, the system 100 models animated eyes using a 3D world space look-at point q. For an eye at point e, local to the head, q_{eye}=(BH)⁻¹q−e. The two-degrees-of-freedom (2DOF) pitch and yaw x, y rotation vector θₑ for the eye can be the spherical polar co-ordinate angles of q_{eye}. Representing an eye as a world space look-at point has particular advantages because most animator rigs use a global look-at point as an eye rotation controller, aligned with an oculocentric motor strategy and the Vestibulo-Ocular Reflex movement is inherently captured.

At block 210, the gaze module 106, as part of the look-at-point generator submodule, creates time sequences of gaze transition targets

$${\{ {t}_{i} , {\vec{q}}_{i} \}}_{i}^{N} ,$$

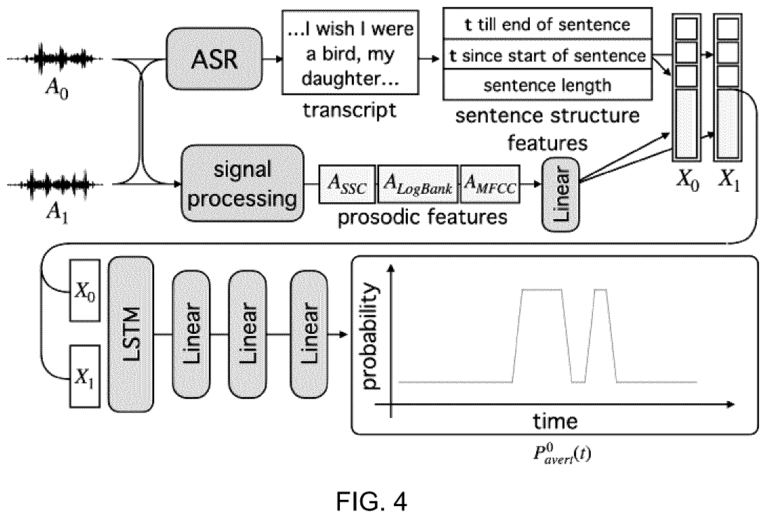

for each character in the conversation. A speech based probability pₐᵥₑᵣₜ(t) for a conversational agent is determined by the gaze module 106 to avert the gaze of the animated character from a conversational partner at every time-step t. In a particular case, the speech based probability can be determined using a recurrent neural network architecture; however, any suitable machine learning model can be used. FIG. 4 illustrates an example diagrammatic implementation of the gaze aversion prediction performed by the gaze module 106. In some cases, varying a velocity profile of the gaze transitions can be used to reflect animated character personality; where a faster velocity profile reflects a jerky and nervous personality while a slower velocity profile reflects a slower and more relaxed personality.

In a particular implementation, the recurrent neural network of the look-at-point generator submodule can use two forms of input. A first input can be prosodic audio features, which, for example, can be encoded using Mel Frequency Cepstral Coefficient (MFCC), log filter bank energies, and Spectral Subband Centroids (SSC). The second form of input can be relative timing of speaking and listening turns obtained from the audio-aligned speech transcripts. Swapping the input speech streams, X₀ and X₁, in a symmetric model allows the gaze module 106 to predict the gaze aversion probability of the conversational partner

$${P}_{avert}^{1} ( t ) .$$

In example experiments, the recurrent neural network model was trained on an “audition” dataset. In this example, after a 9:1 train-test split, each audio performance was divided into 10-second segments, with 5 seconds of overlap between them. The model was then trained with binary entropy loss to produce output that matches the aversion state (0 or 1). Model parameters were updated using the Adam optimizer and training stopped after 1400 epochs. The model in the example experiments achieved 98.4% and 78.9% accuracy on training and validation sets respectively, and generated gaze aversion probabilities that were overall smooth.

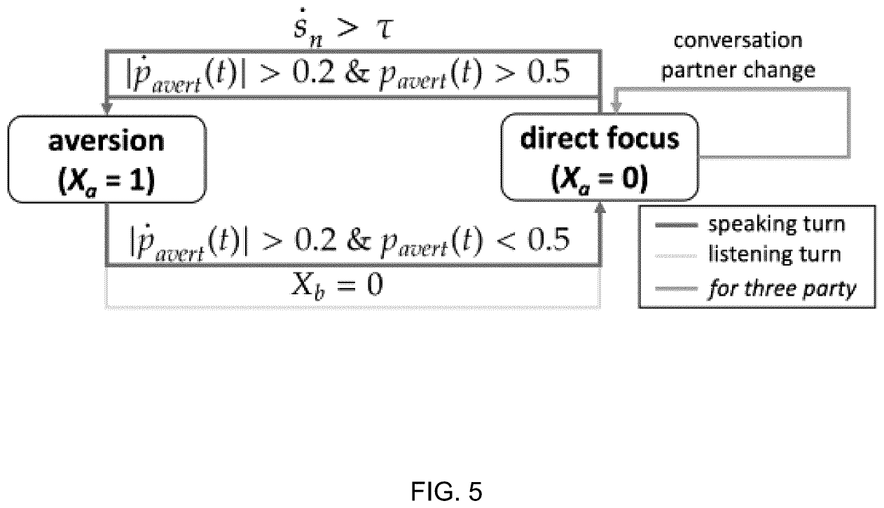

FIG. 5 illustrates an example per-frame gaze state machine implemented by the gaze module 106 for determining gaze and/or aversion. For each conversational agent a, the gaze module 106 operates an aversion state machine Xₐ∈{0,1}, switching between direct focus (gaze-on=0) and aversion (gaze-off=1) states every time-step. Direct focus generates look-at-points on the conversation partner, and aversion employs, for example, a random walk algorithm to generate look-at-points based on scene salience. In an example, the state machine transition is informed by three inputs; however any suitable inputs, or combinations of inputs, can be used:
the speech-based gaze aversion probability pₐᵥₑᵣₜ(t);
the visual salience of each scene object sₙ(t); and
the human tendency to mutually engage gaze, using the gaze state of the conversational partner X_{b}(t).

As shown in the example of FIG. 5, a change of gaze state XQ at time t is primarily controlled by the speech-driven probability of gaze aversion pₐᵥₑᵣₜ(t), but can also be triggered by attending to a scene object n with a large increase in salience sₙ(t); i.e., sₙ(t)>τ (in an example, default τ=0.5 for saliency sₙ∈[0,1]). In some cases, where animations are visually focused on one agent, mutual gaze is not explicitly captured by the learnt gaze probability pₐᵥₑᵣₜ(t). In such cases, the gaze module 106 can model mutual gaze by coupling the state machines of the conversational agents, so that an averted agent (Xₐ=1) can transition to Xₐ=0 to match direct gaze from the conversation partner X_{b}=0. The coupled state machines of agents a and b can be determined in two passes. In the first pass, the gaze module 106 can generate the gaze states of both agents a and b on their speaking turns, considering only the signals pₐᵥₑᵣₜ(t) and sₙ(t). In the second pass, the gaze module 106 can generate gaze states for the listening turns of both agents, using pₐᵥₑᵣₜ(t), \dot{s}ₙ(t), and X_{b} (or Xₐ) computed for the speaker in the first pass.

Once the gaze of both conversing agents has been classified as direct or averted for each frame, the gaze module 106 determines a time sequence of gaze fixations. Deviation from the fixations can be modeled as microsaccades, as described herein. The fixated look-at-points can be determined using a suitable approach. For direct focus, the gaze module 106 can determine whether the animated character is looking at the other interlocutor (for example, at the center of the face by default). For aversion, the gaze module 106 can use, for example, a random walk model to generate a sequence of scene salient look-at-points. The duration of each look-at can be sampled from a known distribution of human fixation and a selected look-at-point sampled from a weighted distribution that favours object salience and gaze shifts of small amplitude. Specifically, when selecting a new gaze target, the gaze module 106 can compute ρᵢ for scene objects i∈{1 . . . k} as:

$${ρ}_{i} = {s}_{i} \cdot {e}^{- κ \cdot max ( 1 , 1 / dur ) \cdot ‖ {v}_{i} - {v}_{prev} ‖}$$

where κ=1.33 in an example, sᵢ and vᵢ are the salience and position of the i^{th} object at the current time, vₚᵣₑᵥ is the previous look-at point, and dur is the length of the aversion interval. The gaze module 106 can then use a soft-max function to determine a probability distribution from ρᵢ, from which the gaze module 106 selects the new scene object (look-at-point). In some cases, the gaze module 106 also uses the aversion duration dur to ensure a small gaze shift for very short (e.g., <1 sec) gaze aversions. The gaze module 106 can sample the time of the next gaze shift from a distribution of fixation duration (e.g., shifted gamma law with α=1.2394, θ=0.1880, and loc=0.08).

At block 212, the gaze module 106, as part of the IK gaze controller submodule, uses these gaze targets determined at block 210 to create realistic per-frame trajectories of head rotation

$${\overline{θ}}_{head}^{x , y} ( t )$$

and gaze q(t). The IK gaze controller submodule provides improved generation of head and eye motion in the present context given a time sequence of gaze targets. The gaze module 106 solves an optimization problem for the head contribution to each gaze shift; then, uses a motion generator to interpolate the desired sequence of head and eye targets.

Given the determined look-at-point planner gaze targets determined at block 210, the gaze module 106 determines a head rotation as an optimization of, for example, three terms to match a learned co-relation between head and gaze angles, minimize head rotation from its predominant focus on the other interlocutor, and minimize eye rotation needed to meet the gaze target. Formally:

$${\overline{θ}}_{head} = * arg {min}_{θ} ( {w}_{p} * {‖ θ - {θ}_{p} ‖}^{2} + {w}_{n} * ( 1 - dwell ) * {‖ θ - {θ}_{n} ‖}^{2} + {w}_{e} * dwell * {‖ θ - {θ}_{e y e} ‖}^{2} )$$

where {wₚ, wₙ, wₑ} are constants each weighting the three terms; θₚ=g(θ_{eye}) is a learned mapping of the most probable head angle for a given gaze direction; θ_{eye} is a direction that the gaze target makes with the neutral eye direction; θₙ is a direction facing the conversational partner, typically close to the neutral head direction; and dwell=min(dur,1) is a weight increasing with gaze target fixation time dur (e.g., clamped at 1).

Small dwell penalizes head movement from neutral, encouraging eye motion to match the gaze target, and the opposite for large dwell. The gaze module 106 determines the weights for each term using, for example, a grid search on different combinations of {wₚ, wₙ, wₑ} to find a set of weights that minimizes the Mean Square Error (MSE) with the annotated head and eye angles generated from an input dataset. Example experiments determined that this optimization results in a lower mean-square-error (MSE) 10.92 compared to 24.26 using θ_{head}=θ_{eye}, 16.04 using θ_{head}=θₙ, or 11.30 using θ_{head}=θₚ.

For motion generation, the gaze module 106 can use a head-eye motion generator to interpolate the sequence of target head and eye angles. For both eye and head motion, movement \dot{θ}(t) is produced by summing up a sequence of sub-movements:

$$\dot{θ} ( t ) = {\sum }_{i}^{N} {b}_{i} v ( {t}_{i}^{0} , {t}_{i}^{1} , t )$$

where each sub-movement has a direction bᵢ and a velocity profile:

$$v ( {t}^{0} , {t}^{f} , t ) = \frac{30}{{( {t}^{f} - {t}^{0} )}^{5}} {( t - {t}^{f} )}^{2} {( t - {t}^{0} )}^{2}$$

The velocity profile for head and eye sub-movements generally differ by motion duration (for example, 100 milliseconds (ms) for the eye, and 600 ms for the head). In some cases, a large gaze shift can be broken down into a sequence of smaller saccades that look more realistic. For example, every 200 ms, an eye sub-movement b; is generated towards a position predicted by the character's probabilistic perception model. In some cases, a similar effect can be achieved by artificially adding noise to the specified look-at-point θ_{eye}:

$${\dot{θ}}_{target , μ} = α ( {θ}_{eye} - {θ}_{prev} )$$

$${\dot{θ}}_{target} ∼ 𝒩 ( μ = {\dot{θ}}_{target , μ} , σ = \frac{1}{4} ( 1 - α ) ‖ {θ}_{target , μ} ‖ )$$

$${θ}_{target , u} = {θ}_{prev} + {\dot{θ}}_{target}$$

By ensuring, for example, α>0.5, the gaze module 106 can guarantee that each gaze shift gets closer to the target look-at-point.

Once a current look-at-point is sufficiently close to a target, the gaze module 106 can use θ_{target}=θ_{eye} to prevent oscillation about the look-at-point. In some cases, a similar approach can be used for head sub-movements, except with σ=0 to ensure smooth head motion.

At block 214, in some cases, the rhythmic motion module 108, as part of the rhythmic head controller submodule, determines rhythmic head motion

$$Δ {θ}_{head}^{x , y , z} ( t ) ,$$

which is added to gaze-based head motion θ̅_{head}(t) to generate a final head motion output θ_{head}(t).

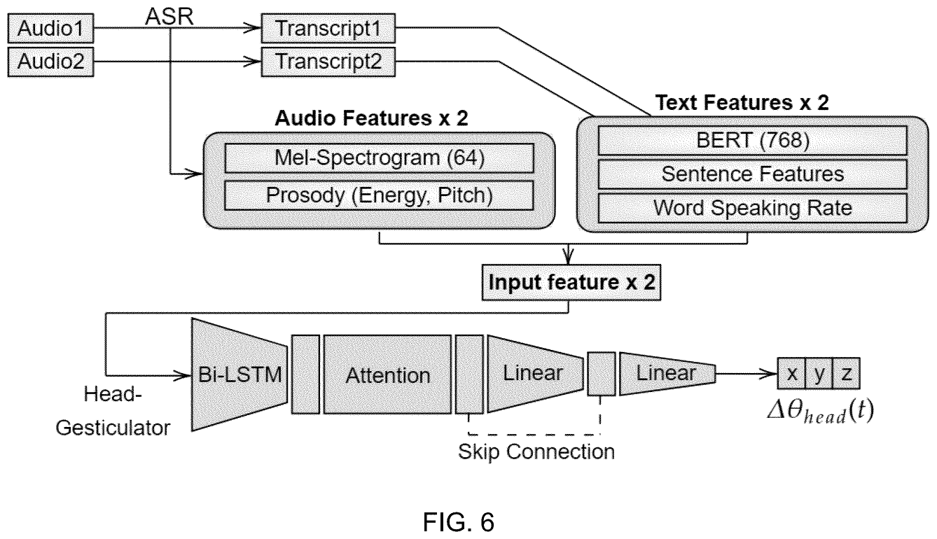

FIG. 6 is a diagram showing an example implementation and architecture to determine rhythmic head rotation values at every time-step. Audio and textual features serve as inputs for such determination. For audio, in an example, Mel-spectrogram can be used along with prosody information (intensity and pitch) of the audio. For text, in an example, Bert features can be used along with the sentence structure features shown in the example of FIG. 4. In some cases, varying the amplitude of the rhythmic head motion can be used to reflect character energy, where a higher amplitude reflects more energy.

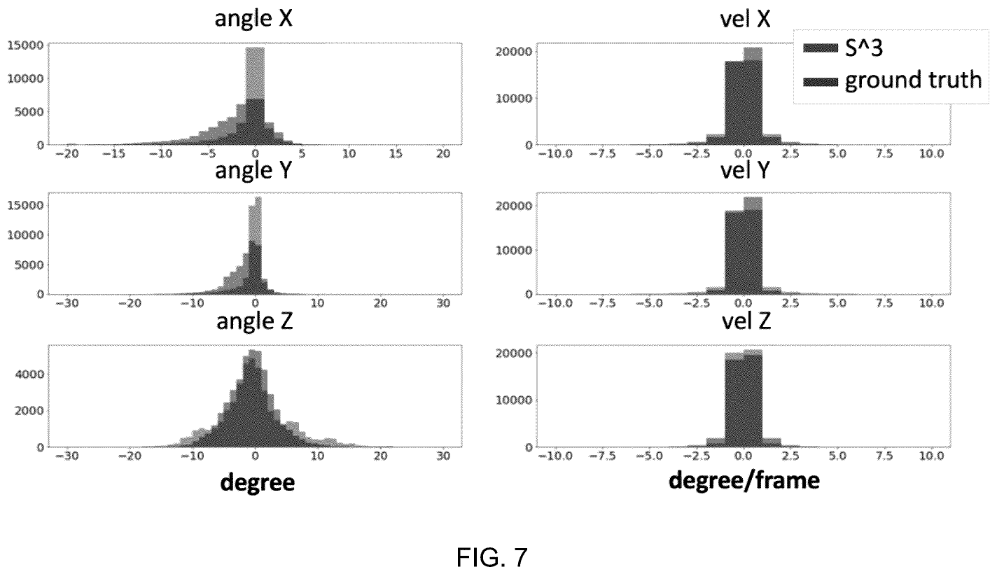

In the example experiments, when trained for 100 epochs using weighted MSE loss for both velocity and position (weighing samples further away from the mean at a higher weight), it was observed that the rhythmic motion module 108 predicts dynamic motion instead of a static mean. This was determined by observing that the position and velocity distribution generated by the rhythmic motion module 108 closely resembles that of the dataset; as illustrated in the rhythmic head motion prediction charts of FIG. 7.

In some cases, at block 216, the post-processing module 110 alters fixation based on modelling microsaccades. When fixated on an object, humans generally perform small (e.g., <2 degrees) and frequent (e.g., 1-2 Hz) saccades within the object to prevent perceptual fading (where vision blurs due to de-sensitized neurons). Microsaccades are useful to emulate realism in gaze animation. The post-processing module 110 determines if any gaze fixation interval is longer than a predetermined time interval, in an example, longer than 0.5 seconds. To determine if this interval is occurring, the post-processing module 110 can samples irregular intervals from [symbol] (0.5,0.1), in an example. Where the gaze fixation interval is longer than the predetermined time interval, the post-processing module 110 performs a small eye rotation Δθₜ (e.g., of amplitude [symbol] (0,2)) that is added to the output gaze animation to enhance realism.

At block 218, the output module 112 outputs the determined animation to the output device 126 or the storage device 124.

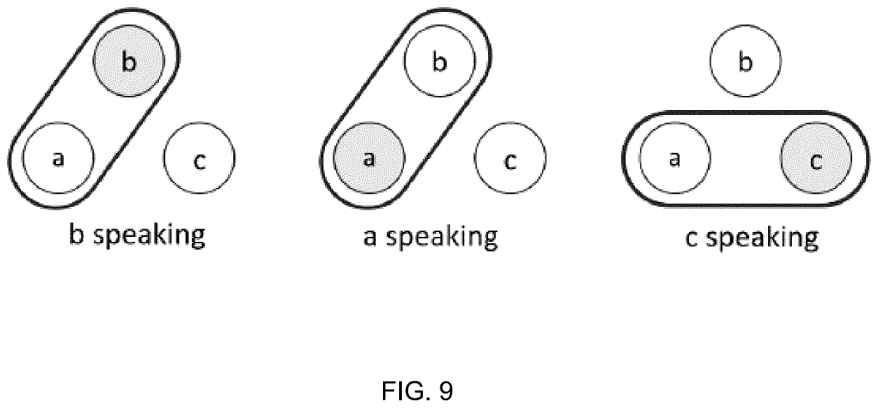

Advantageously, the method 200 can be readily adapted to N-party conversations. FIG. 9 illustrates a diagram of 3-party conversations cast as two dyadic conversations involving a+b and a+c. This example illustrates a three-party conversation with agents a, b, and c, where it can be assumed that people speak one-at-a-time. This example can be cast as pairs of dyadic conversations. From the perspective of a, when b or c is speaking, it is a dyadic conversation between a+b or a+c, respectively. When a is speaking, it is a dyadic conversation between a and the previously speaking agent. The third interlocutor in all cases is simply treated as a salient scene object. Thus, the system 100 can dynamically re-register the conversation partner for each agent when speaking turns change, and reuse the dyadic approach of method 200. Further, changing a conversation partner can automatically trigger a gaze shift.

The present inventors conducted example experiments to verify the substantial advantages of the present embodiments. For the example experiments, a dataset was generated by the present inventors (referred to as an audition dataset). The data for the dataset was sourced from in-the-wild acting audition performances found on Youtube™. The videos all had one on-screen actor, and one off-screen actor, engaging in a conversation. These videos were selected for two reasons: one, unlike TV interviews and talk shows, which often cut from speaker to speaker, the actor being auditioned is always in the frame in an audition clip, providing data and insight for both speaking and listening behaviors; and two, actors are less inhibited by a camera and their performances tend to be varied, natural, and expressive, compared to those captured in a lab setting. The audition dataset comprised of 111 audition videos with a total length of 379 minutes. Overall in the videos, the on-screen actor spends approximately 63% time speaking, and 37% time listening (where the off-screen actor is speaking).

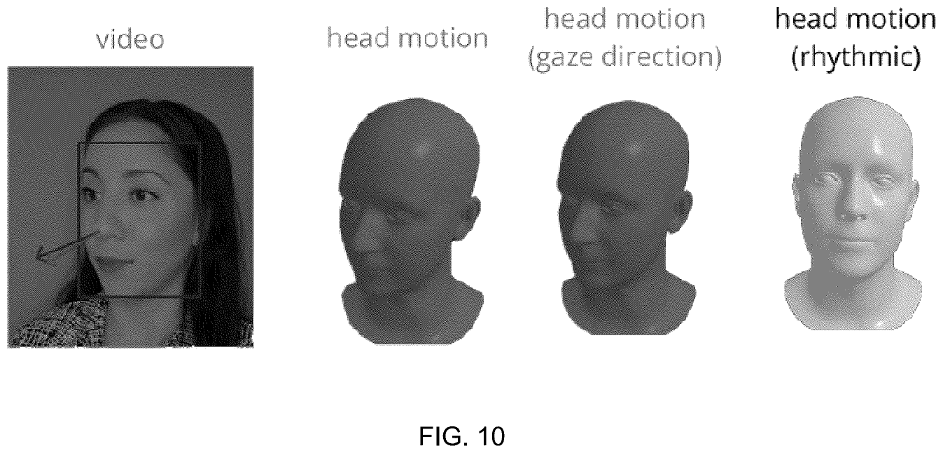

Each video frame in the audition dataset was annotated using binary labels. Each video frame was labelled as either “gaze-on”, “focused” (0) when the on-screen actor is looking at the off-screen actor, or “gaze-off”, “averted” (1) when their gaze is directed elsewhere. The labelling is used to train the audio-driven gaze aversion probability network of the present embodiments. A gaze-estimation model was used to obtain gaze direction from the video. FIG. 10 illustrates audition data with animated head and gaze estimation and isolated rhythmic head rotation animation. A dispersion-based filtering technique was used to ignore micro-saccades, reduce jitter, and segment the gaze signal into a sequence of some N gaze fixations, with direction \vec{p}ⁱ, over time interval <tₛ,tₑ>ᵢ, where i∈{1 . . . N}. Based on the insight that speakers in an audition tend to spend the majority of the time looking at the conversation partner, the example experiments used a Gaussian mixture model to cluster \vec{p}ᵢ, and used the center of the biggest cluster as the direction \vec{p}_{off} towards the center of the off-screen actor. The angular size of the off-screen actor was represented as a cone angle ϕ (ϕ∈[0,π/2]) around \vec{p}_{off}. A gaze direction \vec{p} was thus averted from the off-screen actor if it deviated >=ϕ from \vec{p}_{off}. For unit gaze vectors:

$$averted ( \vec{p} , {\vec{p}}_{off} , ϕ ) = ⌈ cos ( ϕ ) - ( \vec{p} . {\vec{p}}_{off} ) ⌉$$

Given that dispersion-filtering removes micro-saccades, the majority of the remaining gaze shifts to and from the off-screen actor are desirable to count as gaze focus and/or aversion transitions. A line search on ϕ∈[ϵ,π/2] was performed to maximize the total number of focus and/or aversion gaze transitions, where ϵ provides a minimum speaker size angle (pick ϵ as the smallest cone angle to contain half the gaze directions in the off-screen actor cluster). In this way:

$${max}_{ϕ} ( {\sum }_{i = 1}^{N - 1} \vert averted ( {\vec{p}}_{i} , {\vec{p}}_{off} , ϕ ) - averted ( {\vec{p}}_{i + 1} , {\vec{p}}_{off} , ϕ ) \vert )$$

The determined averted was used to label video frames, and the results strongly appeared to match viewer expectations.

In the example experiments, in order to train a model for predicting rhythmic head motion using audio and text transcript features, rhythmic head movements were isolated in the audition dataset from gaze-driven head motion. To identify eye-driven head movements, the example experiments implemented a Dynamic Time Warping (DTW) based algorithm. Note that DTW is useful because, while the head always moves complementary to the eyes, it is often delayed (e.g., 100-200 ms) and always moves slower. The DTW measures the optimal time-similarity between the temporal rotations of gaze θ_{eye}(t) and head θ_{head}(t)

$$( {θ}_{head}^{z} ( t )$$

is ignored in the comparison).

In the example experiments, gaze and head rotations were determined for the input dataset. In this example, an ETH-XGaze model was used to compute eye rotations

$${θ}_{eye}^{x , y} ,$$

and Mediapipe was used to determine head rotation

$${θ}_{head}^{x , y , z} ,$$

from the input videos. Both head and eye rotations were de-noised using a Gaussian filter. These were then given as input to the DTW algorithm, which first determines L₂ distance d(eᵢ,hⱼ), between each pair of frames eᵢ in θ_{eye}(tₛ) and hⱼ in θ_{head}(tₛ); where tₛ indicates the sliding window samples from the eye and head rotation sequences. A cost matrix, C, of size n×m, was constructed where n is the length of θ_{eye}(tₛ) and m is the length of θ_{head}(tₛ). The cost matrix cells (initialized to ∞), were iteratively filled to compute the minimal cost based on neighboring cells:

$$C ( i , j ) = d ( {e}_{i} , {h}_{j} ) + min ( C ( i - 1 , j ) , C ( i , j - 1 ) , C ( i - 1. j - 1 ) )$$

The dissimilarity was accumulated along different possible paths, in an accumulated cost matrix D as:

$$D ( i , j ) = C ( i , j ) + min ( D ( i - 1 , j ) , D ( i , j - 1 ) , D ( i - 1 , j - 1 ) )$$

Starting from D(n,m), one can backtrack through D to find the optimal warping path (left, diagonal, or up at each step) ending at D (1,1); with the smallest accumulated alignment cost Dₒₚₜᵢₘₐₗ. The rhythmic head movement is then determined as follows:
For head rotation samples with a low alignment cost (Dₒₚₜᵢₘₐₗ≤τ, where τ is the mean of all optimal alignment costs for the entire video), head and gaze are correlated; the aligned gaze rotation can be subtracted from the head rotation sample to get the head rotation sample hₗ(tₛ).
For head rotation samples with a high alignment cost (Dₒₚₜᵢₘₐₗ>τ), head and gaze are independent, and the mean pose of the sample can be oriented to the front-facing rest head pose, and a new head rotation sample hₕ(tₛ) can be created.
The rhythmic head rotation samples hₗ(tₛ) and hₕ(tₛ) can be concatenated as originally aligned in time and interpolation can be used to remove any remaining discontinuities due to shot changes, noise in head/eye tracking, extreme face rotations and occlusions, to produce a rhythmic head motion signal Δθ_{head}(t).

In the example experiments, the present inventors manually checked about 10% of the videos in the audition dataset to confirm that both the gaze annotation and the rhythmic head motion computation strongly matched viewer expectation. The example experiments determined that there was 98.4% and 78.9% accuracy on training and validation data for the aversion probability network. Additionally, the state machine, when correctly averted, picked the correct aversion gaze cluster in the audition dataset with 90.7% accuracy. Additionally, the predicted IK head angle for gaze fixations had a lower Mean Square Error of 10.92° (compared against the audition dataset) than other approaches. While fixated head and eye values in the audition dataset were reliable, their motion trajectories can be noisy, and thus were not compared to the head and eye motion interpolation output. Additionally, the rhythmic head controller produced a distribution of rhythmic head motion that closely matched the audition dataset. Further, the example experiments illustrated that the system can be adapted to generate gaze for pairwise dyadic, N-party conversations.

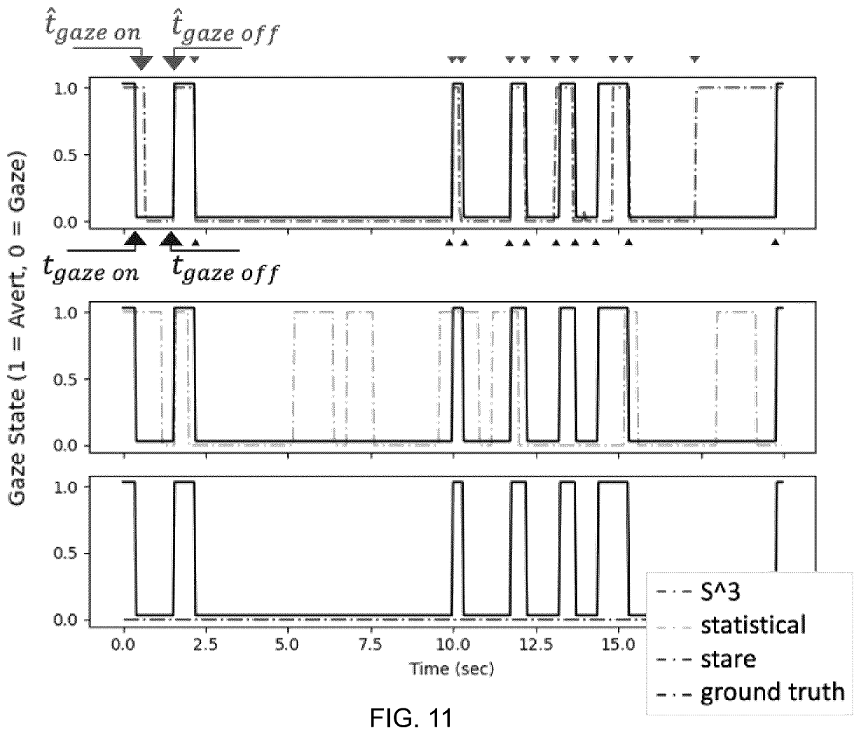

Beyond high per-frame accuracy in predicting a gaze focus and/or aversion state, the example experiments analyzed the performance of the system 100 on various metrics, compared to a few baselines. Specifically it was compared against stare, a commonly used model with no gaze aversion, and a statistical model that alternately samples gaze focus and/or aversion intervals randomly, from distributions of focus and/or aversion interval length in the audition dataset. The outputs of the three models, relative to ground truth, for an example 20 second clip, are shown in FIG. 11.

The example experiments evaluated each model's predictions

$${\{ {\hat{p}}_{n} \}}_{n = 1}^{N}$$

against ground truth data

$${\{ {p}_{n} \}}_{n = 1}^{N}$$

using accuracy, Jaccard similarity (IOU), gaze-on/off transition accuracy, and aversion instance ratio. Accuracy measures the per-frame agreement between \hat{p}ₙ and pₙ i.e.

$$( acc = 1 - ( {\sum }_{n = 1}^{N} \vert {\hat{p}}_{n} = {p}_{n} \vert ) / N ) .$$

Jaccard similarity measures the frame overlap between predicted gaze aversion and ground truth (1 is the indicator function below):

$${{\sum }_{n = 1}}^{N} \frac{1 \{ {\hat{p}}_{n} = {p}_{n} = 1 \}}{1 ( {\hat{p}}_{\vert} n = 1 \} + 1 \{ {p}_{n} = 1 \}}$$

Gaze-on (or off) accuracy is a binary measure of alignment between a predicted gaze transition and the closest ground truth, at perceptually significant moments of gaze transition from aversion to focus. The aversion instance ratio simply counts the number of aversions, relative to those in ground truth.

Table 1 shows a comparison of the approaches to predict gaze aversion:

TABLE 1

| | | | | | Avert |
|---|---|---|---|---|---|
| Model | Acc | IOU | Gaze-on Acc | Gaze-off Acc | Instances |
| Stare | 0.63 | 0.00 | 0.00 | 0.00 | 0.00 |
| Statistical | 0.47 | 0.23 | 0.31 | 0.33 | 1.04 |
| System 100 | 0.79 | 0.36 | 0.53 | 0.53 | 1.08 |

From Table 1, it can be seen that while stare (performing no aversion) achieves 63% accuracy (because gaze focus is predominant), it performs poorly on the other perceptual metrics. The statistical model also fails to generate gaze aversion at times that perceptually make sense. The system 100 performs well on all metrics with high accuracy, Jaccard similarity, good alignment of gaze transition, and generates a similar number of gaze transitions as the ground truth.

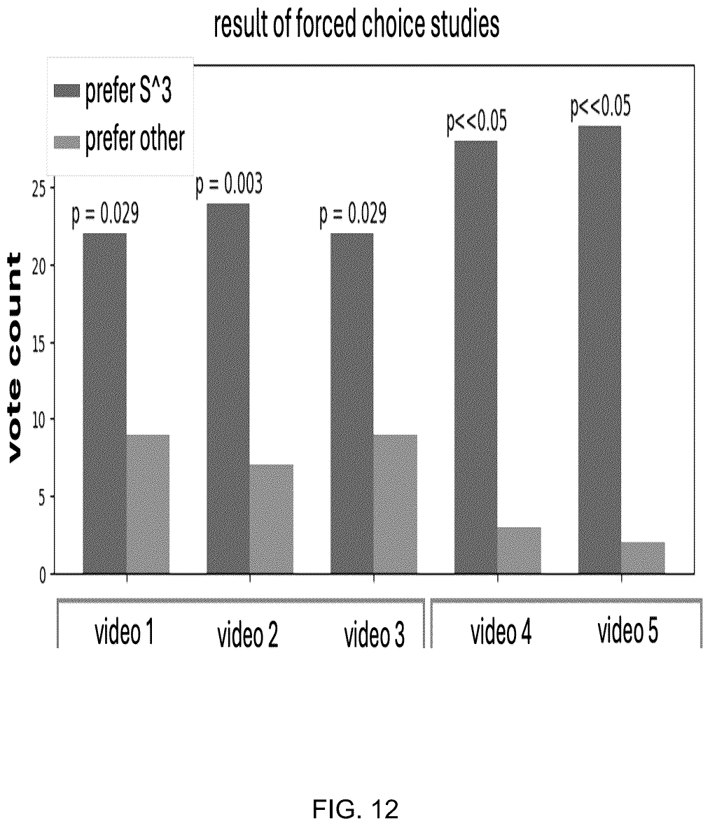

Advantageously, the system 100 combines speech audio and scene context in a model for realistic conversational head and eye motion, as shown in Table 1. In the example experiments, camera views and framing were matched to the output of previous approaches. A 4 point (weak or strong preference) forced choice user study with 36 users was performed between the output of the system 100 (referred to as ‘S\hat{ }3’) and the previous approaches. The users were instructed to focus on head and eye motion and ignore rendered appearance and other factors. The users were asked to provide reasons for their choice, and overall impression of the animations. The results of the forced choice experiment are shown in FIG. 12. A binomial test evaluated the significance of the result, with a p-value displayed on the top of each bar graph.

For the other approaches, facial animators noted that the head movements were too smoothed but also had many discontinuities, and that the movements look repetitive. Casual users found the gaze aimless and does not look connected with speech. They also noted a lot of head movements and were divided between it seeming “expressive” or “erratic”. Viewers felt the prior approaches had very static eyes, head movement that looked robotic, and gaze that lacked eye contact. In contrast, facial animators found use of the system 100 to have “convincing mutual gaze”, reasonable gaze targets, high-quality motion control, and generated great aversion that fits the sentence structure and audio. Casual users praised the gaze produced by the system 100 as sensible, natural, and the performance as lifelike.

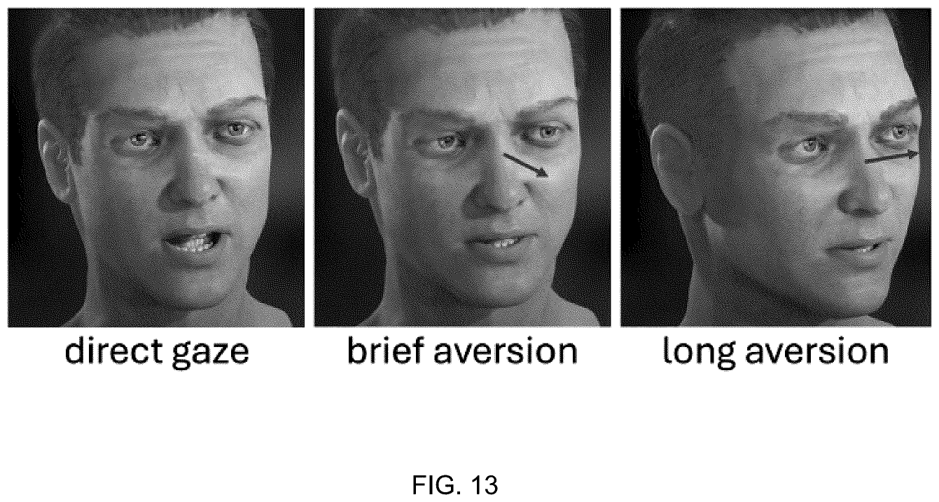

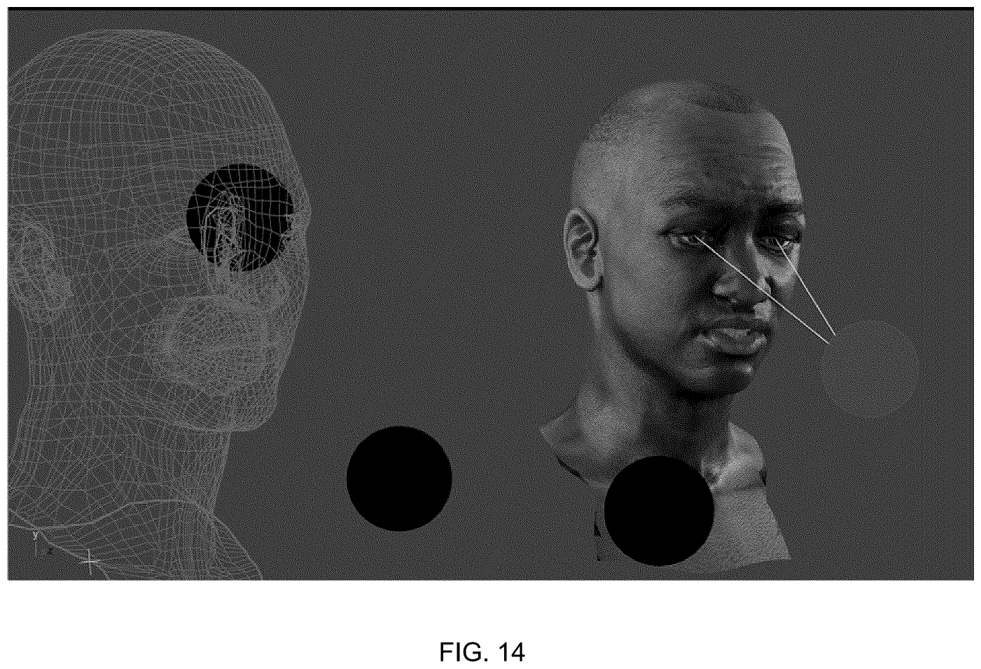

In the example experiments, eight clips from film/TV were used from outside of the audition dataset. Each clip was diarized, and a 3D scene with the speakers and 3-5 salient points created to match the clip. Directorial scripting was also employed on clips involving the dialogue “Royal with Cheese” and “Dear Dolores” to establish contextual importance of a moving car windshield and reading a letter, respectively. For each clip, an audio-driven facial performance was generated on the character rigs shown, for example, in FIG. 13. The system 100 was used to automatically generate head and eye motion trajectories, that are mapped to control the head/neck and eye transforms on the rigs. It should be noted that the animated head and eye rotations produced by the system 100 can be easily combined with any existing head and eye motion to support a variety of rigs and workflows. FIG. 14 illustrates an example use of the system to determine gaze of the animated character to provide a realistic animation, showing circles representing gaze transition targets while the character is reading a letter.

As illustrated in the example experiments, the present embodiments provide a modular approach to conversational head and eye animation. Ego-centric gaze behavior is advantageously modelled as speech audio based transitions of gaze focus and/or aversion, refined by exo-centric gaze behavior based on 3D scene saliency, to output conversational gaze trajectories. Gaze control then generates head and eye animation to satisfy the conversational gaze trajectories and is combined with audio-driven rhythmic head motion and script-driven emblematic head and eye gestures. Favorable comparison to prior art, viewer critique, and compelling results show the present embodiments to be a particularly advantageous approach to audio-driven head and eye animation. The present embodiments can have a number of potential applications in the realm of computer animation; such as use for generating media and video games. Other applications may become apparent.

Although the invention has been described with reference to certain specific embodiments, various modifications thereof will be apparent to those skilled in the art without departing from the spirit and scope of the invention as outlined in the claims appended hereto.

1. A method of determining conversational gaze control for computer animation of a character, the method executed on a processing unit, the method comprising:
receiving transcripted speech audio;
determining time sequences of gaze transition targets for a series of time-steps using a state machine that resolves between direct focus and aversion at each time-step;
determining trajectories of head motion and gaze of the character for each time-step using the determined gaze transition targets; and
outputting the trajectories of head motion and gaze for computer animation of the character.

2. The method of claim 1, further comprising receiving directorial inputs from a user that are embedded within the transcripted speech audio.

3. The method of claim 2, wherein the directorial inputs comprise one of look-at tags to amplify salience of an object, directional tags to specify ego-centric aversion behavior, or override tags to force focus or aversion behaviour.

4. The method of claim 1, further comprising determining visually salient portions of a setting for the computer animation to determine locations for the gaze of the character.

5. The method of claim 1, wherein determining the time sequences of gaze transition targets comprises determining a speech-based probability indicating whether to avert the gaze of the character from a conversational partner.

6. The method of claim 5, wherein the speech based probability is determined using a recurrent neural network model, the recurrent neural network model taking as input prosodic audio features and relative timing of speaking and listening turns obtained from the transcripted speech audio.

7. The method of claim 4, wherein, during direct focus, look-at-points are generated on a conversational partner, and wherein, during aversion, look-at-points are generated using a random walk algorithm based on scene salience.

8. The method of claim 5, wherein transitions of the state machine are determined based on one or more of the speech-based probability, a visual salience of each scene object, and a gaze state of a conversational partner.

9. The method of claim 1, wherein determining the trajectories of head motion and gaze of the character for each time-step using the determined gaze transition targets comprises optimizing for a head rotation to a shift in gaze, and comprises interpolating a sequence of head and eye targets using a motion generator.

10. The method of claim 9, wherein optimizing for the head rotation comprises an optimization involving minimization of head rotation from a predominant focus on another character, matching a learned co-relation between head and gaze angles, and minimization of eye rotation to meet the gaze transition target.

11. The method of claim 9, wherein the motion generator comprises interpolation of a sequence of target head and eye angles determined by summing a sequence of sub-movements.

12. The method of claim 1, further comprising adding rhythmic head motion to the trajectory of the head motion.

13. The method of claim 1, further comprising altering fixation of the trajectory of the gaze with eye rotations where a gaze fixation interval is longer than a predetermined time interval.

14. A system of determining conversational gaze control for computer animation of a character, the system comprising a processing unit and a data storage, the data storage comprising instructions for the processing unit to execute:
an input module to receive transcripted speech audio;
a gaze module to determine time sequences of gaze transition targets for a series of time-steps using a state machine that resolves between direct focus and aversion at each time-step, and to determine trajectories of head motion and gaze of the character for each time-step using the determined gaze transition targets; and
an output module to output the trajectories of head motion and gaze for computer animation of the character.

15. The system of claim 14, wherein determining the time sequences of gaze transition targets comprises determining a speech-based probability indicating whether to avert the gaze of the character from a conversational partner.

16. The system of claim 14, wherein, during direct focus, look-at-points are generated on a conversational partner, and wherein, during aversion, look-at-points are generated using a random walk algorithm based on scene salience.

17. The system of claim 16, wherein transitions of the state machine are determined based on one or more of the speech-based probability, a visual salience of each scene object, and a gaze state of a conversational partner.

18. The system of claim 14, wherein determining the trajectories of head motion and gaze of the character for each time-step using the determined gaze transition targets comprises optimizing for a head rotation to a shift in gaze, and comprises interpolating a sequence of head and eye targets using a motion generator.

19. The system of claim 1, wherein the processing unit further executes a rhythmic motion module to add rhythmic head motion to the trajectory of the head motion.

20. The system of claim 1, wherein the processing unit further executes a post-processing module to alter fixation of the trajectory of the gaze with eye rotations where a gaze fixation interval is longer than a predetermined time interval.
